(19) United States
(12) Patent Application Publication
(10) Pub. No.: US 2019/0234228 A1
(43) Pub. Date: Aug. 1, 2019

(54) BLADED ROTOR WITH INTEGRATED GEAR FOR GAS TURBINE ENGINE

(71) Applicant: PRATT & WHITNEY CANADA CORP., Longueuil (CA)

(72) Inventors: Enzo MACCHIA, Kleinburg (CA); Sean DOWNARD, Brampton (CA); Daniel ALECU, Toronto (CA); George GUGLIELMIN, Longueuil (CA)

(21) Appl. No.: 15/882,655

(22) Filed: Jan. 29, 2018

(51) Int. Cl. F01D 15/12; F01D 5/34

(52) U.S. Cl. CPC F01D 15/12; F01D 5/34; F05D 2250/231; F05D 2220/32; F05D 2250/232; F05D 2240/20

(57) ABSTRACT

An assembly of a shaft and a rotor disk comprises a shaft configured to rotate at a first angular speed S1 about a shaft rotational axis. A bladed rotor includes a disk adapted to support blades, the disk having a rotor rotational axis, the disk being integrally and monolithically formed with at least one rotor gear, the rotor gear being concentric with the disk about the rotor rotational axis. A gear train includes a shaft gear fixed to the shaft, the gear train having at least one gear meshed with the rotor gear for imparting a rotation to the bladed rotor at angular speed S2, wherein the angular speed S1≠the angular speed S2.

### TECHNICAL FIELD

The present disclosure relates to rotors of the type found in gas turbine engines.

### BACKGROUND OF THE ART

Compressor stages are conventionally found in gas turbine engine to compress air. Compression ratio may be as a function of the angular speed of compressor rotors. Compressor rotors are often mounted to a turbine shaft whose angular speed is constrained by turbine limitations. Consequently, compressor rotors integrally connected to turbine shaft in 1:1 speed ratios may be limited by turbine shaft angular speed constraints. Gear boxes and like arrangements may be used to increase the speed ratios, but such mechanisms may have impacts on the overall weight and size of a gas turbine engine.

### SUMMARY

In accordance with an embodiment, there is provided a bladed rotor comprising a disk adapted to support blades, the disk having a rotational axis, the disk being integrally and monolithically formed with at least a first gear configured to be coupled to an adjacent gear, the first gear being concentric with the disk about the rotational axis.

In accordance with another embodiment, there is provided an assembly of a shaft and a rotor disk comprising: a shaft configured to rotate at a first angular speed S1 about a shaft rotational axis; a bladed rotor including a disk adapted to support blades, the disk having a rotor rotational axis, the disk being integrally and monolithically formed with at least one rotor gear, the rotor gear being concentric with the disk about the rotor rotational axis; and a gear train including a shaft gear fixed to the shaft, the gear train having at least one gear meshed with the rotor gear for imparting a rotation to the bladed rotor at angular speed S2, wherein the angular speed S1≠the angular speed S2.

### DESCRIPTION OF THE DRAWINGS

FIG. 1 is a perspective view, sectioned, of a bladed rotor in accordance with the present disclosure;

FIG. 2 is a sectional view of a rotor disk in accordance with another embodiment of the present disclosure; and

FIG. 3 is a schematic longitudinal section view of an arrangement of a bladed rotor in accordance with the present disclosure as a mounted to a turbine shaft.

FIG. 4 is a sectional view of radial fins of an exemplary embodiment of the bladed rotor of FIG. 1.

### DETAILED DESCRIPTION

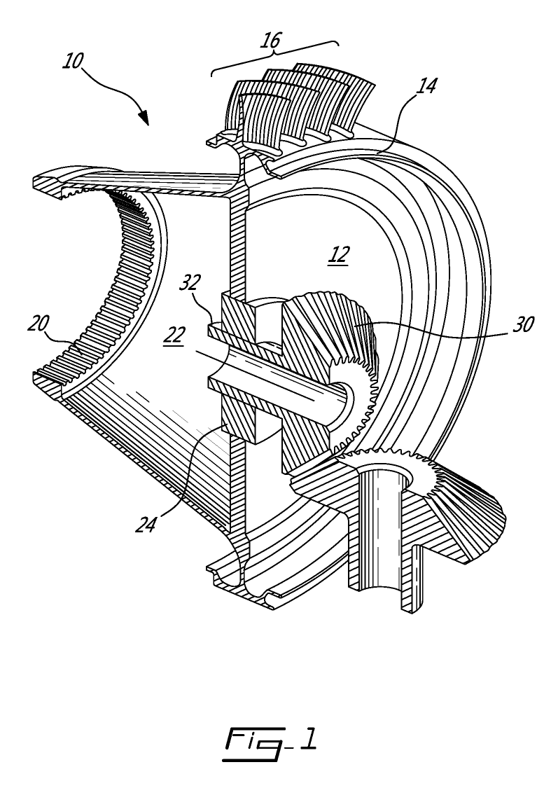

Referring to the drawings and more particularly to FIG. 1, there is illustrated at 10 a bladed rotor. The bladed rotor 10 may be used in gas turbine engines, for instance in the form of a compressor rotor for an axial compressor. The gas turbine engine is any appropriate type of engine, including as examples a turbofan engine, a turboprop engine. The bladed rotor 10 may be part of a multi-stage compressor, a boost compressor, among other contemplated uses. The bladed rotor 10 may receive torque from a turbine shaft, in a single-spool configuration, from a high-pressure turbine shaft or low-pressure turbine shaft in a two-spool configuration, etc. The gas turbine engine may have more spools.

The bladed rotor 10 may be an integrally bladed rotor (IBR) as in FIG. 1. The bladed rotor 10 may also have inserted blades. As shown in FIG. 1, the bladed rotor 10 consequently has a disk 12. The disk 12 may have a flat disk portion as FIG. 1, as one of numerous possible configurations, including a conical disk, etc. The disk 12 supports a rim 14 upon which are circumferentially distributed a plurality of blades 16. In FIG. 1, only four blades 16 are shown for the simplicity of the figure, but the rim 14 conventionally supports blades 16 all around its circumference. While FIG. 1 shows the integration of the blades 16 in the rim 14, an insert arrangement may be used as well, with any appropriate connection arrangements to secure the blades 16 to the rim 14.

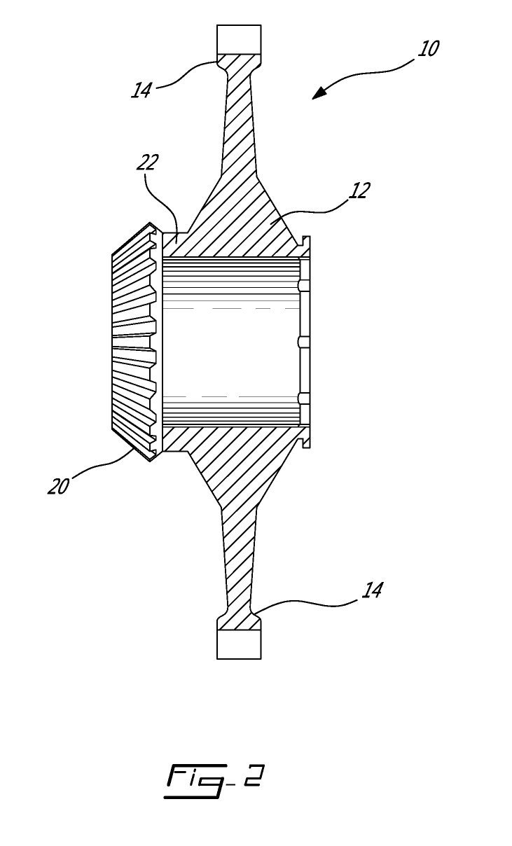

As part of the integral construction, the bladed rotor 10 has a gear 20 integrally connected to it. The gear 20 may be integrally formed into the disk 12, for instance in a monoblock or monolithic construction. The gear 20 may be part of the disk 12 as in FIG. 1, with the gear 20 formed at an end of a tube 22 connected to a remainder of the disk 12. The tube 22 may have a frustoconical shape as in FIG. 1, a cylindrical shape as in FIG. 2, etc. The gear 20 may be connected directly to the flat disk portion of FIG. 1 instead of having its own tube 22. The gear 20 may be any type of gear. FIG. 1 shows the gear 20 as an internal gear, but may also be an external gear as in FIG. 2. The gear 20 may be a spur gear, a helical gear, a bevel gear, a curvic, etc.

Referring to FIG. 1, a connector 24 may be added to the flat disk portion to support a gear 30 and its shaft 32. The connector 24 may be integrally formed into the flat disk portion or may be a separate component fixed to the flat disk portion, or to any other part of the bladed rotor 10. Moreover, the gear 30 and its shaft 32 may be integrally formed with the bladed rotor 10. In an embodiment, gear 20 differs from gear 30.

The geometries and arrangements described above are achieved through different manufacturing techniques. In an embodiment, the bladed rotor 10 is the result of additive manufacturing techniques, including 3D printing and material deposition, with the bladed rotor 10 being for example made of metal(s). It is contemplated to fabricate the parts separately as well, and then fix them to one another using appropriate techniques, such as welding (e.g., electron-beam welding), brazing, assembled with threads and a nut, curvic coupled, flanges, etc.

The bladed rotor 10 with integrated gear 20 and/or gear 30 has the gear 20 and/or the gear 30 in axial proximity with the rotor blades 16, with the 1:1 concurrent rotation resulting from integral connection. The gear 20 may be meshed with other gear(s) to cause a speed differential with another rotating component and/or counter rotation. The gear 30 may also be meshed with other gear(s) to cause a speed differential with another rotating component, and the gear 30 may change an orientation of rotational axis, if it is a bevel gear as in FIG. 1. Moreover, the interconnection of the bladed rotor 10 with a coaxial gear component may provide some rotational support to the bladed rotor 10 complementarily or alternatively to a bearing.

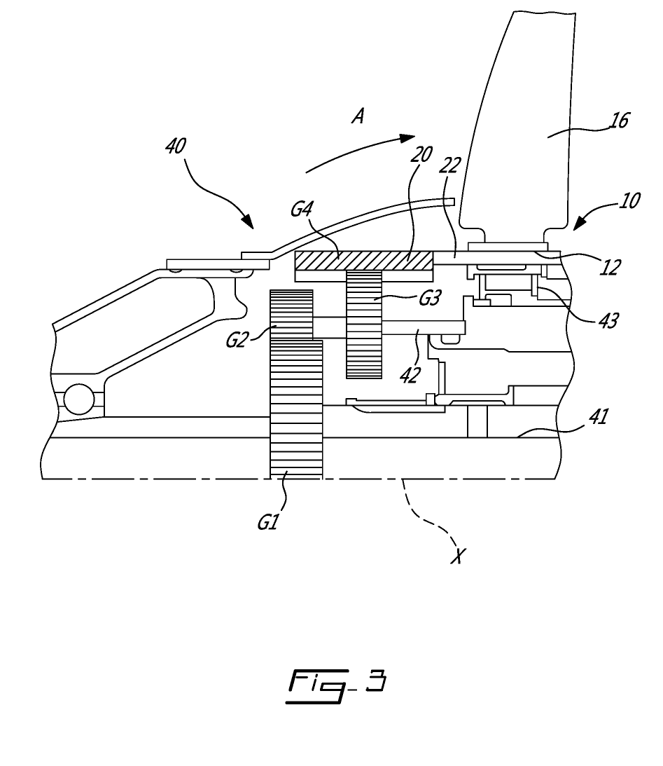

For example, FIG. 3 illustrates a compressor section 40 of a turbofan gas turbine engine of a type preferably provided for use in subsonic flight. The compressor section 40 pressurizes the air, for the compressed air to be mixed with fuel and ignited in a combustor for generating an annular stream of hot combustion gases. A turbine section then extracts energy from the combustion gases. In the illustration of FIG. 3, the rotational axis is generally shown as X, with only a portion of the components above the axis X being shown. However, some components, such as the bladed rotor 10, have an annular shape whereby their mirror images would be symmetrically found relative to the axis X if the image were not segmented below the rotational axis X.

The compressor section 40 defines an annular gaspath A in which stator vanes and rotor blades (a.k.a., airfoils) sequentially alternate. By rotation of the rotor blades part of the bladed rotor 10, a static pressure increases in a downstream direction of the gaspath A, as indicated by directional arrow. A shaft 41 rotates about the rotational axis X at a speed S1. A gear G1 is mounted to the shaft 41, and is for example a spur gear. Gear G2 is meshed with gear G1. According to an embodiment, gear G2 is a plurality of planet gears (e.g. three or more planet gears G2). The planet gears G2 are idlers in the compression section 40, i.e., they each rotate about their own rotational axes (parallel to the rotational axis X), but are stationary. The planet gears G2 may be rotatably supported by shafts 41 (one shown) and supported by bearings 42, with each planet gear G2 being paired with another planet gear G3 on the shafts 41. The planet gears G3 may have different dimensions than their paired planet gears G2. For instance, as in FIG. 3, G2<G3.

G4 is the gear 20 of the bladed rotor 10, and consequently only a upper half is shown. The gear G4, in FIG. 3 an internal gear, is meshed with the planets G3. As the planets G3 are stationary, rotation of the planets G3 induces a rotation of gear G4, and thus of the the bladed rotor 10, about rotational axis X, at a speed S2. The bladed rotor 10 may have its disk 12 supported by bearings 43, in such a way that the bladed rotor 10 is rotationally supported by both the meshing engagement with the planets G3 and the bearings 43. As a result of the arrangement shown in FIG. 3, angular speed S1 is not equal to angular speed S2. In accordance with another embodiment, the gear arrangement between the shaft 41 and the bladed rotor 10 is such that S1<S2. As observed, an angular speed differential, such as an angular speed increase, may be achieved in a compact manner along the longitudinal dimension defined along axis X. As an alternative embodiment of the gear train presented above, the gear 20 is meshed directly to G2, thus acting as a ring gear to the planets G2, in a single stage gear train arrangement.

The gear train arrangement of the compressor section 40 of FIG. 3, while being one of numerous arrangements possible, allows an increase of the angular speed of the bladed rotor 10 relative to the shaft 41, whereby it may result in a reduction in a number of boost stages in a multi-stage axial compressor. Likewise, part complexity may be reduced along with cost and reliability), causing a weight saving in the engine. The bladed rotor 10 may be treated and/or coated after manufacturing to reach suitable material strength and compatibility if necessary by part standards. In an IBR arrangement, the airfoils are combined with gears and with a disk in one piece. As another contemplated arrangement, two shafts can drive three or more compressor stages, and this may result in an optimization of aerodynamics, a reduction in carbon emissions and noise.

Accordingly, FIG. 3 shows one of numerous assemblies of a shaft, the shaft 41, and a rotor disk, the bladed rotor 10. The shaft 41 rotates at a first angular speed S1 about a shaft rotational axis X. The bladed rotor 10 includes the disk 12 adapted to support blades 16. The disk has a rotor rotational axis. In the illustrated embodiment, the rotor rotational axis is coincident with the shaft rotation axis X, but may be spaced and parallel to it, or transverse (e.g., perpendicular). The disk may be integrally and monolithically formed with a rotor gear, such as the gear 20, the rotor gear 20 being concentric with the disk 12 about the rotor rotational axis, here the shaft rotation axis X. A gear train of any appropriate configuration has a shaft gear G1 fixed to the shaft 41. The gear train has one or more gears G3 meshed with the rotor gear G4 for imparting a rotation to the bladed rotor 10 at angular speed S2, wherein the angular speed S1 # the angular speed S2.

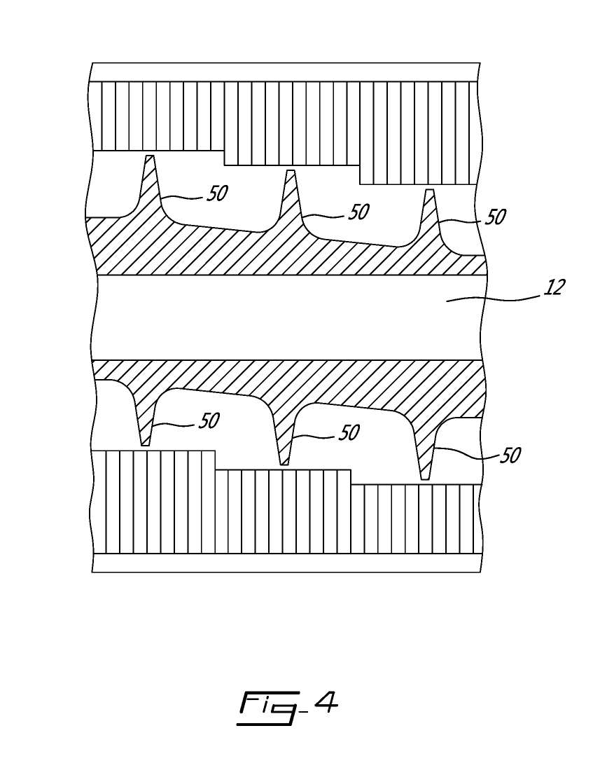

Referring to FIG. 4, there is shown radial fins 50 that may be integrally part of the bladed rotor 10 to seal a gas path between the bladed rotor 10 and its surrounding environment. The surrounding environment may form annular steps, as one contemplated configuration.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A bladed rotor comprising a disk adapted to support blades, the disk having a rotational axis, the disk being integrally and monolithically formed with at least a first gear configured to be coupled to an adjacent gear, the first gear being concentric with the disk about the rotational axis.

2. The bladed rotor according to claim 1, wherein the bladed rotor is an integrally bladed rotor, the blades being monolithically formed with the disk.

3. The bladed rotor according to claim 1, wherein the disk has a tube supporting the first gear.

4. The bladed rotor according to claim 3, wherein the tube has one of a frusto-conical geometry and a cylindrical geometry.

5. The bladed rotor according to claim 3, wherein the disk has a disk portion, with a second gear connected to the disk portion, for concurrent rotation with the first gear.

6. The bladed rotor according to claim 5, further comprising an annular connector secured to the disk portion, the annular connector supporting a shaft of the disk portion.

7. An assembly of a shaft and a rotor disk comprising:
a shaft configured to rotate at a first angular speed (S1) about a shaft rotational axis;
a bladed rotor including a disk adapted to support blades, the disk having a rotor rotational axis, the disk being integrally and monolithically formed with at least one rotor gear, the rotor gear being concentric with the disk about the rotor rotational axis; and
a gear train including a shaft gear fixed to the shaft, the gear train having at least one gear meshed with the rotor gear for imparting a rotation to the bladed rotor at a second angular speed (S2), wherein the first angular speed (S1) is not equal to the second angular speed (S2).

8. The assembly according to claim 7, wherein the shaft rotational axis and the rotor rotational axis are coincident.

9. The assembly according to claim 7, wherein the bladed rotor is an integrally bladed rotor, the blades being monolithically formed with the disk.

10. The assembly according to claim 7, wherein the gear train includes a plurality of planet pairs, each said planet pair having a first planet gear meshed with the shaft gear, and a second planet gear meshed with the rotor gear.

11. The assembly according to claim 10, wherein the rotor gear is an internal gear.

12. The assembly according to claim 7, wherein the gear train and the rotor gear are sized such that the first angular speed (S1) is smaller than the second angular speed (S2).

13. The assembly according to claim 7, further comprising at least one bearing supporting the bladed rotor.

14. The assembly according to claim 7, wherein the shaft is a turbine shaft of a gas turbine engine, and the bladed rotor is a compressor rotor.

15. (canceled)

16. The assembly according to claim 7, wherein the disk has a tube supporting the first gear.

17. The assembly according to claim 16, wherein the tube has one of a frusto-conical geometry and a cylindrical geometry.

18. The assembly according to claim 16, wherein the disk has a disk portion, with a second gear connected to the disk portion, for concurrent rotation with the first gear.

19. The assembly according to claim 18, further comprising an annular connector secured to the disk portion, the annular connector supporting a shaft of the disk portion.
